(19) United States
(12) Patent Application Publication
(10) Pub. No.: US 2025/0214514 A1
(43) Pub. Date: Jul. 3, 2025

(54) Storing Apparatus

(71) Applicant: ENROAD CO.,LTD, Jiangsu (CN)

(72) Inventors: Haiming TAN, Jiangsu (CN); Guangshan WANG, Jiangsu (CN)

(73) Assignee: ENROAD CO.,LTD, Jiangsu (CN)

(21) Appl. No.: 19/001,834

(22) Filed: Dec. 26, 2024

(30) Foreign Application Priority Data
Dec. 29, 2023 (CN) 202311852122.9

(51) Int. Cl. B60R 9/055

(52) U.S. Cl. CPC B60R 9/055

(57) ABSTRACT

The present disclosure provides a storing apparatus, suitable for being attached to a vehicle. The storing apparatus includes a body and a cover, the body and the cover are connected through a hinge mechanism, and the hinge mechanism allows the cover to be rotatably opened and closed relative to at least one edge of the body. The hinge mechanism includes a first link rod member and a second link rod member, the first link rod member is swingably connected between the body and the cover, and the second link rod member is swingably connected between the body and the cover.

### CROSS-REFERENCE TO RELATED APPLICATIONS

The present application claims priority to Chinese Patent Application No. 202311852122.9, filed on Dec. 29, 2023 and entitled “STORING APPARATUS”, the content of which and its modified content incorporated herein by reference in its entirety.

### TECHNICAL FIELD

The present disclosure relates to the technical field of accommodation of articles on vehicles, in particular to a storing apparatus.

### BACKGROUND

A roof box is a storing apparatus configured on a roof of a vehicle, which includes a body and a cover that can be opened and closed relative to each other, and a space for accommodating articles is formed between the body and the cover. Due to the fact that the roof box is applied on the roof of the vehicle, high-speed movement and bumps of the vehicle have higher requirements for the stability of buckling of the cover and the body of the roof box, as well as the fluid resistance performance of the roof box. Typically, the body and the cover of the roof box need to be made of hard materials and constructed with a certain streamline shape. One end of the cover and one end of the body are rotatably connected by a hinge, and the other ends are locked with a metal buckle. In a closed state, the cover should be in close contact with the body and there should be no obvious gaps, so that the articles are prevented from falling out of the box. However, due to the fact that the cover and body are made of the hard materials, the cover in close contact in the closed state is prone to abutting-interference with the body when rotated to be opened relative to the body, making it difficult to open or opening at a small angle, which makes it inconvenient to take and place the articles. One solution in the prior art for this is to arrange side walls of the body to shrink inward relative to the edges of the body, in order to form an avoiding space that avoids abutting of the cover and the body when the cover is opened. This occupies the space inside the box and affects the streamlined design of the body.

Therefore, it is necessary to propose a novel roof storing apparatus to solve the above-mentioned problems.

### SUMMARY

The present disclosure provides a storing apparatus to solve the problems mentioned in the background above.

In order to implement the above inventive objectives, the present disclosure provides a storing apparatus, including a body and a cover. The body and the cover are connected through a hinge mechanism, and the hinge mechanism allows the cover to be rotatably opened and closed relative to at least one edge of the body, wherein, the hinge mechanism includes: a first link rod member, swingably connected between the body and the cover, at least two ends of the first link rod member being connected to the body and the cover in a pivoted mode respectively through a first pivot shaft and a second pivot shaft; a second link rod member, swingably connected between the body and the cover, at least two ends of the second link rod member being connected to the body and the cover in a pivoted mode respectively through a third pivot shaft and a fourth pivot shaft; and a first base member, configured to be releasably connected to the body or the cover. Both the first pivot shaft and the third pivot shaft are connected to the first base member to be configured such that the first pivot shaft, the third pivot shaft and the first base member are able to be integrally released from the body or the cover. A distance between the first pivot shaft and the third pivot shaft is defined by the first base member to be kept unchanged, and when the first link rod member rotates through the first pivot shaft and the second link rod member rotates through the third pivot shaft to open the cover, a distance between the fourth pivot shaft and the first pivot shaft is increased to enable the cover to move away from the body.

The present disclosure further provides a storing apparatus, suitable for being attached to a vehicle. The storing apparatus includes a body and a cover, the body and the cover are connected through a hinge mechanism, and the hinge mechanism allows the cover to be rotatably opened and closed relative to at least one edge of the body. The hinge mechanism includes a first link rod member and a second link rod member; the first link rod member is swingably connected between the body and the cover, and at least two ends of the first link rod member are connected to the body and the cover in a pivoted mode respectively through a first pivot shaft and a second pivot shaft; and the second link rod member is swingably connected between the body and the cover, and at least two ends of the second link rod member are connected to the body and the cover in a pivoted mode respectively through a third pivot shaft and a fourth pivot shaft. A distance between the first pivot shaft and the third pivot shaft and a distance between the second pivot shaft and the fourth pivot shaft are both kept unchanged, such that the body, the cover, the first link rod member and the second link rod member constitute a four-link mechanism; and the first link rod member and the second link rod member are jointly connected with one end of the body or the cover, and are configured to be releasably connected to the body or the cover.

### BRIEF DESCRIPTION OF DRAWINGS

The accompanying drawings constituting a part of the present application are intended to provide a further understanding of the present disclosure, and schematic embodiments of the present disclosure and their illustrations are used to explain the present disclosure, and do not constitute an appropriate limitation to the present disclosure. In the accompanying drawings:

FIG. 1 is a stereoscopic diagram of an embodiment of a storing apparatus of the present disclosure in a closed state.

FIG. 2 is a side view of FIG. 1 when a cover is omitted.

FIG. 3 is a stereoscopic diagram of an embodiment of a storing apparatus of the present disclosure in an opened state.

FIG. 4 is a side view of FIG. 3 when a cover is omitted.

FIG. 5 is a schematic diagram of a hinge mechanism of an embodiment of a storing apparatus of the present disclosure in a closed state.

FIG. 6 is a schematic diagram of a hinge mechanism of an embodiment of a storing apparatus of the present disclosure in an opened state.

FIG. 7 is an exploded view of a hinge mechanism of an embodiment of a storing apparatus of the present disclosure.

FIG. 8 is a stereoscopic diagram of an embodiment of a hinge mechanism of a storing apparatus of the present disclosure.

FIG. 9 is a stereoscopic diagram from another perspective of an embodiment of a hinge mechanism of a storing apparatus of the present disclosure.

FIG. 10 is a stereoscopic diagram of another embodiment of a hinge mechanism of a storing apparatus of the present disclosure.

FIG. 11 is a stereoscopic diagram from another perspective of another embodiment of a hinge mechanism of a storing apparatus of the present disclosure.

### REFERENCE NUMERALS

storing apparatus (100); body (1); locking seat (11); locking hook (111); cover (2); hinge mechanism (3); first link rod member (31); base plate (311); pivoting side plate (312); connecting sheet (313); second link rod member (32); first base member (33); second base member (34); arc groove (340); top plate part (341); side plate part (342); strength accumulating piece (35); padding block (36); first pivot shaft (41); second pivot shaft (42); third pivot shaft (43); fourth pivot shaft (44); and guide shaft (45).

### DESCRIPTION OF EMBODIMENTS

The technical solution in embodiments of the present disclosure will be clearly and completely described below in combination with the accompanying drawings in the embodiments of the present disclosure. Apparently, the described embodiments are part of the embodiments of the present disclosure, not all of them. The following description of at least one exemplary embodiment is actually illustrative, and should not be construed as any limitation on the present disclosure and its application or use. Based on the embodiments of the present disclosure, all other embodiments obtained by those of ordinary skill in the art without any creative work fall within the protection scope of the present disclosure.

It should be noted that the terms used here are only intended to describe specific implementations and are not intended to limit exemplary implementations according to the present application. As used herein, unless otherwise explicitly stated in the context, the singular form is also intended to include the plural form. Additionally, it should further be understood that, when the terms “comprising” and/or “including” are used in this specification, they indicate the presence of features, steps, operations, devices, assemblies and/or combinations thereof.

Unless otherwise specified specifically, the relative arrangement, numerical expressions and values of components and steps described in these embodiments do not limit the scope of the present disclosure. At the same time, it should be understood that for ease of description, the dimensions of the various parts shown in the accompanying drawings are not drawn according to an actual proportional relation. For techniques, methods, and devices known to those of ordinary skill in the related art, detailed discussions may not be made, but in appropriate circumstances, such techniques, methods, and devices should be considered as part of the granted specification. In all the examples shown and discussed here, any specific value should be interpreted as illustrative and not restrictive. Therefore, other examples of exemplary embodiments may have different values. It should be noted that: similar numerals and letters represent similar items in the following accompanying drawings. Therefore, once an item is defined in one accompanying drawing, it does not need to be further discussed in subsequent accompanying drawings.

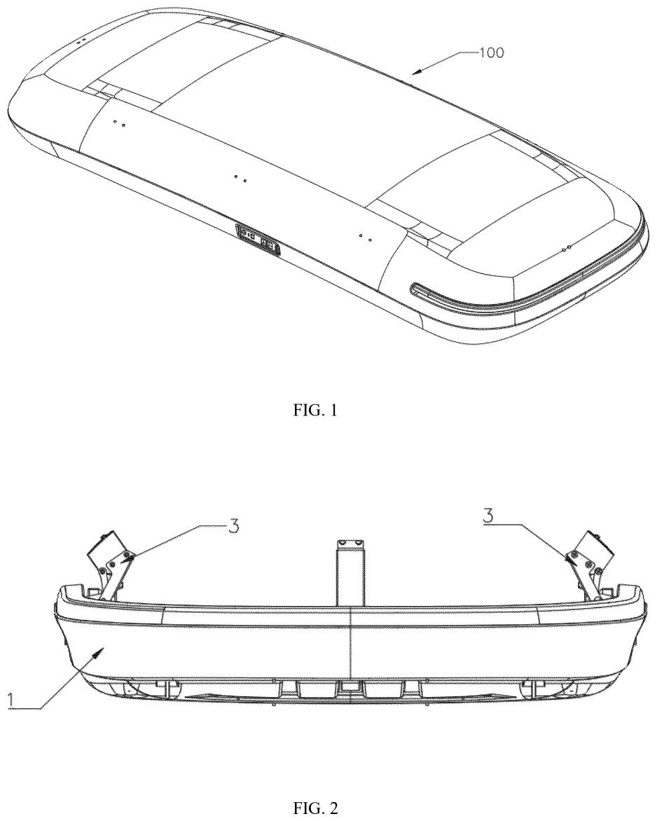

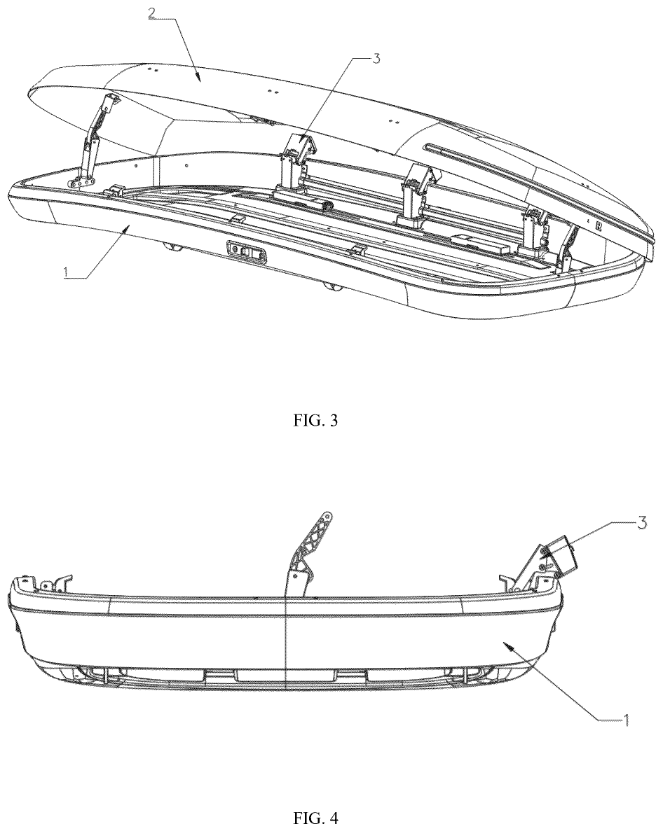

Referring to FIG. 1 to FIG. 4, the present application provides a storing apparatus 100. The storing apparatus 100 is suitable for being attached to a vehicle, and, especially, the storing apparatus 100 is a roof box assembled on a top of the vehicle. The storing apparatus 100 includes a body 1 and a cover 2. The body 1 and the cover 2 are connected through hinge mechanisms 3, and the hinge mechanisms 3 allow the cover 2 to be rotatably opened and closed relative to at least one edge of the body 1. In some embodiments, the hinge mechanisms 3 are configured at two opposite edges of the storing apparatus 100, and when the cover 2 is opened, the hinge mechanism 3 at one of the edges is released from the body 1 or the cover 2, and the cover 2 rotates around the hinge mechanism 3 at the other edge. In the present embodiment, the hinge mechanisms 3 are arranged at two opposite edges of the cover 2, the body 1 is provided with locking seats 11 which match with the hinge mechanisms 3 correspondingly, and the hinge mechanisms 3 can be locked with the locking seats 11 to form rotary connecting mechanisms, so that the cover 2 rotates around the hinge mechanisms 3 relative to the body 1 to be opened. The hinge mechanisms 3 and the locking seats 11 may further be unlocked, so as to be used as an open side when the cover 2 is opened relative to the body 1. That is, in the present embodiment, the cover 2 may be opened from two sides of the body 1 to facilitate the use by users.

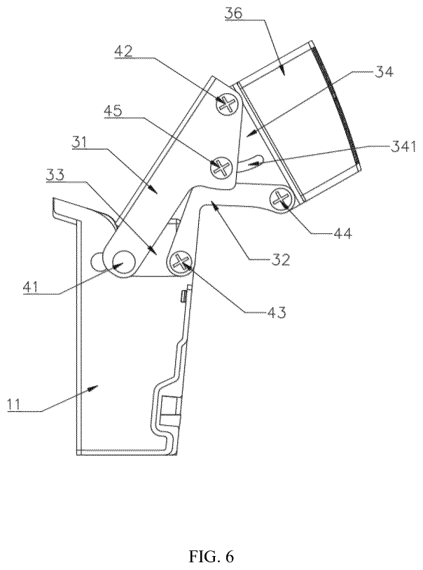

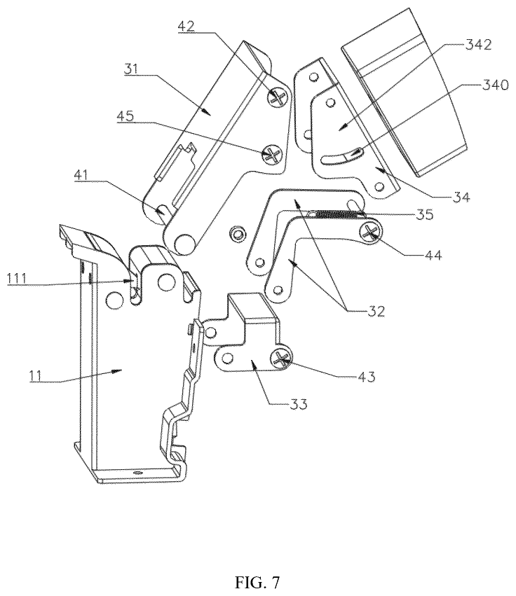

Referring to FIG. 5 to FIG. 9, each hinge mechanism 3 includes a first link rod member 31 and a second link rod member 32. The first link rod members 31 are swingably connected between the body 1 and the cover 2, and at least two ends of each first link rod member 31 are connected to the body 1 and the cover 2 in a pivoted mode respectively through a first pivot shaft 41 and a second pivot shaft 42. At least two ends of each second link rod member 32 are connected to the body 1 and the cover 2 in a pivoted mode respectively through a third pivot shaft 43 and a fourth pivot shaft 44. A distance between the first pivot shaft 41 and the third pivot shaft 43 is kept unchanged, and a distance between the second pivot shaft 42 and the fourth pivot shaft 44 is kept unchanged, so that the body 1, the cover 2, the first link rod member 31 and the second link rod member 32 constitute a four-link mechanism. When the cover 2 rotates relative to the body 1 to be opened, the first link rod members 31 and the second link rod members 32 rotate relative to the body 1 and the cover 2 respectively, and a distance between the fourth pivot shafts 44 and the first pivot shafts 41 is increased to enable the cover 2 to move away from the body 1. The hinge mechanisms 3 included in the storing apparatus 100 provided by the present application constitute the four-link mechanisms, such that the cover 2 cannot abut against the body 1 when opened relative to the body 1 without arranging an inward-retraction avoiding space on the body 1.

Each hinge mechanism 3 further includes a first base member 33, and the first base member 33 is configured to be releasably connected to one of the body 1 and the cover 2. In the present embodiment, the first base members 33 are releasably connected to the body 1. Both the first pivot shafts 41 and the third pivot shafts 43 are connected to the first base members 33 to be configured such that the first pivot shafts 41, the third pivot shafts 43 and the first base members 33 are able to be integrally released from the body 1. The distance between the first pivot shafts 41 and the third pivot shafts 43 is defined by the first base members 33 to be kept unchanged. In the present embodiment, since the ends of the hinge mechanisms 3 connected to the body 1 need to be releasable from the locking seats 11 of the body 1 so as to open and lock the cover 2 relative to the body 1, if the first pivot shafts 41 and the third pivot shafts 43 included in the hinge mechanisms 3 are independently connected to the body 1 respectively, the distance between the first pivot shafts 41 and the third pivot shafts 43 will be changed after the hinge mechanisms 3 are released from the locking seats 11 on the body 1, the uniqueness of moving paths of the four-link mechanisms is affected, and then opening and closing action processes of the cover 2 are affected. Therefore, in the present application, the first base members 33 may define the distance between the first pivot shafts 41 and the third pivot shafts 43 to be kept unchanged, and the hinge mechanisms 3 can be integrally released from the locking seats 11 conveniently. In the present embodiment, each locking seat 11 includes a locking hook 111, and at least one of the first pivot shafts 41 and the third pivot shafts 43 is constructed as a locking pin to be locked with the locking hooks 111 in a pivoted mode. After being locked, the locking pins and the locking hooks 111 constitute one of pivoting axes in a moving process of the hinge mechanisms 3.

Each hinge mechanism 3 further includes a second base member 34 opposite to the corresponding first base member 33, and the second pivot shafts 42 and the fourth pivot shafts 44 are connected to the second base members 34 in a pivoted mode. In the cover opening process, one of the first base members 33 and the second base members 34 is fixedly connected to the body 1, and the other is fixedly connected to the cover 2. A sliding guide piece is arranged between at least one of the first link rod members 31 and the second link rod members 32 and at least one of the first base members 33 and the second base members 34. In the present embodiment, the sliding guide pieces are arranged between the first link rod members 31 and the second base members 34. Each sliding guide piece includes arc grooves 340 and guide shafts 45 capable of sliding in the arc grooves 340. Each second base member 34 includes a top plate part 341 fixedly connected to the body 1 or the cover 2 and side plate parts 342 extending from side edges of the top plate part 341, wherein the arc grooves 340 are formed in the side plate parts 342 of the second base member 34. The sliding guide pieces may guide relative motions between the first link rod members 31 and the second base members 34, so that the relative motions therebetween are smoother. There are two side plate parts 342 arranged oppositely, the first link rod members 31 and the second link rod members 32 each include two pivoting side plates arranged oppositely which are correspondingly pivoted on the two side plate parts 342 of the second base members 34.

The second base members 34 are fixedly connected to the body 1 or the cover 2, and padding blocks 36 are configured between the second base members 34 and the body 1 or the cover 2. By adopting the padding blocks 36 of different thicknesses, the heights of the hinge mechanisms 3 connected to the body 1 or the cover 2 can be adjusted, which may adapt to bodies 1 and covers 2 with different sizes or shapes, thus improving the universality of the hinge mechanisms 3.

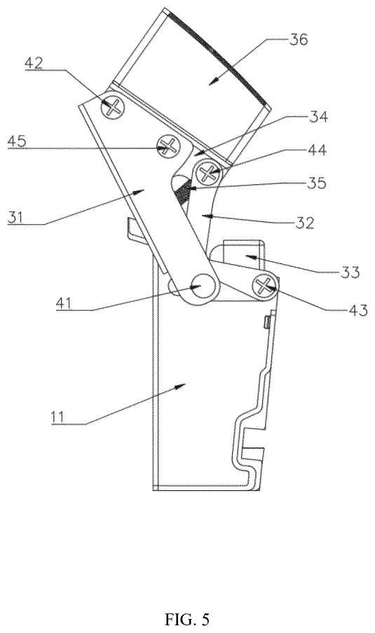

Continuing to refer to FIG. 5 to FIG. 9, each first link rod member 31 is an integrated member which includes a base plate 311 and pivoting side plates 312 extending in a bent mode from two opposite sides of the base plate 311; and each second link rod member 32 is a split member which includes two parts separately arranged at two ends of the corresponding third pivot shaft 43 and the corresponding fourth pivot shaft 44. The second link rod members 32 are closer to the edge than the first link rod members 31, wherein the second link rod members 32 are bent to form avoiding areas on sides facing the edge, and the avoiding areas are used to avoid abutting against the edge in an opening process of the cover 2. In the present embodiment, each second link rod member 32 is approximately in an L shape, and an approximately right-angle space formed on the inner side of the L shape is the avoiding area. As shown in FIG. 4 and FIG. 6, the second link rod members 32 abut against the edge of the body 1 to define a maximum opening position of the cover 2. A distance between the third pivot shafts 43 and the fourth pivot shafts 44 on the second link rod members 32 is smaller than a distance between the first pivot shafts 41 and the second pivot shafts 42 on the first link rod members 31, such that, in the cover opening process, an appropriate opening angle can be formed between the cover 2 and the body 1. In one embodiment, the distance between the first pivot shafts 41 and the second pivot shafts 42 is 7-9 cm, the distance between the third pivot shafts 43 and the fourth pivot shafts 44 is 4-6 cm, the distance between the first pivot shafts 41 and the third pivot shafts 43 is 1.5-5.3 cm, and the distance between the second pivot shafts 42 and the fourth pivot shafts 44 is 3.5-5.5 cm.

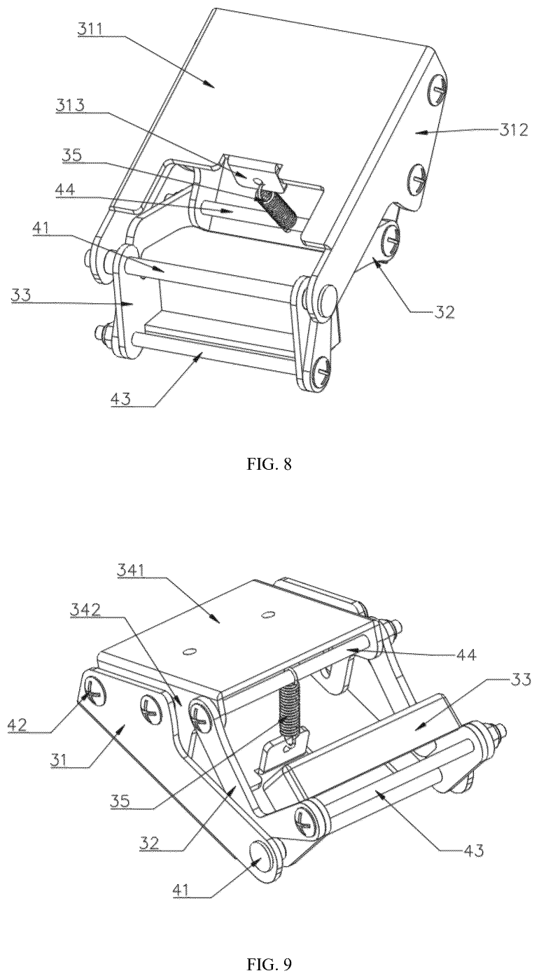

Referring to FIG. 5, FIG. 6, FIG. 8 and FIG. 9, each hinge mechanism 3 further includes a strength accumulating piece 35. The strength accumulating pieces 35 are configured such that, when the hinge mechanisms 3 are released from the body 1 or the cover 2, the strength accumulating pieces 35 included in the hinge mechanisms 3 keep the hinge mechanisms 3 in a state suitable for being locked with the locking hooks 111 on the body 1 or the cover 2 when the cover 2 is closed. That is, the strength accumulating pieces 35 are used to define relative positions of the first link rod members 31 and the second link rod members 32 when the hinge mechanisms 3 are in a state of being released from the locking seats 11. The strength accumulating pieces 35 are further configured such that, when the cover 2 rotates around the hinge mechanisms 3 to be opened, the strength accumulating pieces 35 included in the hinge mechanisms 3 are in a strength accumulating state for elastic deformation to produce elastic restoring force. The elastic force produced by strength accumulation of the strength accumulating pieces 35 helps to provide assistant cover closing force when the cover 2 is closed. In the present embodiment, the strength accumulating pieces 35 are springs, one end of each spring is connected to the corresponding fourth pivot shaft 44, and the other end of the spring is connected to the corresponding first link rod member 31. When the cover 2 is in an opened state, the strength accumulating pieces are in a stretched strength-accumulation state. The strength accumulating pieces 35 are extension springs with two ends being connecting rings, the connecting ring at one end sleeves the corresponding fourth pivot shaft 44, and the connecting ring at the other end sleeves a connecting sheet 313 of the corresponding first link rod member 31. The connecting sheets 313 are formed by extending from the base plates 311 of the first link rod members 31 in a bent mode, the connecting sheets 313 are bent to an angle facilitating the connection with the connecting rings on the extension springs, and the connecting sheets 313 are provided with connecting holes for the connecting rings to be hooked in the connecting holes so as to achieve the connection.

The strength accumulating pieces 35 are not merely limited to the form of the springs in the present embodiment, and in other embodiments of the strength accumulating pieces 35 (not shown in the figure), the strength accumulating pieces 35 may further be replaced with components made of other elastic materials, such as leaf springs, elastic plastic and elastic silicone rubber.

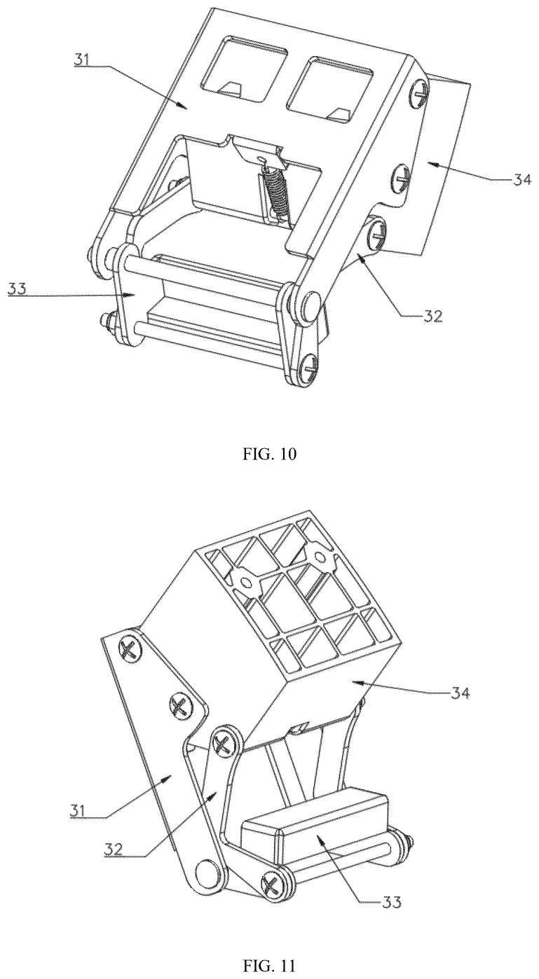

Referring to FIG. 10 and FIG. 11, in another embodiment of hinge mechanisms 3, second base members 34 are constructed as plastic blocks so as to be directly fixed to a cover 2 or a body 1. That is, the second base members 34 and the padding blocks 36 in the previous embodiment are integrated as the second base members 34 in the present embodiment. Other components in the present embodiment are the same as those in the previous embodiment, which are omitted here.

It is to be noted that, although the specific embodiments and accompanying drawings of the present application are described using the example that the locking seats 11 are arranged on the body 1 and the hinge mechanisms 3 are connected to the cover 2, it should be understood that, the same effect can also be achieved by arranging the locking seats 11 on the cover 2 and the hinge mechanisms 3 on the body 1, which is also an embodiment included in the present application.

Referring to FIG. 1 to FIG. 6, a using process is as follows: when the cover 2 is in the closed state, after the locking hooks 111 on the locking seats 11 are unlocked, the cover 2 may be lifted from the edge of the unlocked side, then the cover 2 rotates with the hinge mechanisms 3 arranged at the edge of the other side opposite to the edge of the unlocked side as rotating points, and the hinge mechanisms 3 move to the state shown in FIG. 6 from the state shown in FIG. 5, so that the cover is opened; and when the cover 2 is in the opened state, the edge of the opened side of the cover 2 is pressed down, then the cover 2 rotates with the hinge mechanisms 3 as rotating points, and the hinge mechanisms 3 move to the state shown in FIG. 5 from the state shown in FIG. 6 until the first pivot shafts 41 on the hinge mechanisms 3 arranged at the edge of the opened side are locked by the locking hooks 111 on the locking seats 11, so that the cover is closed.

To sum up, it can be seen from the above description that, the present disclosure achieves the following technical effects:

the storing apparatus provided by the present application has the hinge mechanisms 3, and the hinge mechanisms 3 constitute the four-link mechanisms, such that the cover 2 cannot abut against the body 1 when opened relative to the body 1 without arranging the inward-retraction avoiding spaces on the body 1.

In the description of the present disclosure, it should be understood that, directional or positional relationships indicated by directional words such as “front, rear, upper, lower, left, right”, “transverse, vertical, perpendicular, horizontal”, and “top, bottom” are usually based on directional or positional relationships shown in the accompanying drawings, only for the ease of describing the present disclosure and simplifying the description. In the absence of contrary explanation, these directional words do not indicate or imply that devices or elements referred to must have a specific orientation or be constructed and operated in a specific orientation, and therefore cannot be understood as limiting the scope of protection of the present disclosure; and the directional words “inner, outer” refer to the inside and outside relative to own contours relative to each component itself.

For ease of description, spatial relative terms such as “above”, “over”, “on the upper surface of”, “on”, etc. can be used here to describe the spatial positional relationship between a device or feature shown in the drawing and other devices or features. It should be understood that the spatial relative terms are intended to encompass different orientations in use or operation in addition to the orientation of the devices described in the drawings. For example, if the devices in the drawings are inverted, the device described as “over other devices or structures” or “above other devices or structures” will be then positioned as “below other devices or structures” or “under other devices or structures”. Therefore, the exemplary term “over” may include two orientations: “over” and “below”. The device may also be positioned in other different ways (rotated by 90 degrees or in other orientations), and corresponding explanations should be provided for the spatial relative description used here.

In addition, it should be noted that the use of words such as “first” and “second” to define parts is for the purpose of distinguishing between corresponding parts conveniently. If not otherwise stated, the above words do not have a special meaning and therefore cannot be understood as limiting the scope of protection of the present disclosure.

The foregoing descriptions are only preferred embodiments of the present disclosure and are not used to limit the present disclosure. For those skilled in the art, the present disclosure can have various modifications and changes. Any modification, equivalent replacement, improvement, etc. made within the spirit and principle of the present disclosure should be included in the scope of protection of the present disclosure.

What is claimed is:

1. A storing apparatus, suitable for being attached to a vehicle, the storing apparatus comprising a body and a cover, the body and the cover being connected through a hinge mechanism, and the hinge mechanism allowing the cover to be rotatably opened and closed relative to at least one edge of the body, wherein the hinge mechanism comprises:
a first link rod member, swingably connected between the body and the cover, at least two ends of the first link rod member being connected to the body and the cover in a pivoted mode respectively through a first pivot shaft and a second pivot shaft;
a second link rod member, swingably connected between the body and the cover, at least two ends of the second link rod member being connected to the body and the cover in a pivoted mode respectively through a third pivot shaft and a fourth pivot shaft; and
a first base member, configured to be releasably connected to the body or the cover; wherein
both the first pivot shaft and the third pivot shaft are connected to the first base member to be configured such that the first pivot shaft, the third pivot shaft and the first base member are able to be integrally released from the body or the cover; and wherein
a distance between the first pivot shaft and the third pivot shaft is defined by the first base member to be kept unchanged, and when the first link rod member rotates through the first pivot shaft and the second link rod member rotates through the third pivot shaft to open the cover, a distance between the fourth pivot shaft and the first pivot shaft is increased to enable the cover to move away from the body.

2. The storing apparatus according to claim 1, wherein: the hinge mechanism further comprises a second base member opposite to the first base member, and the second pivot shaft and the fourth pivot shaft are connected to the second base member in a pivoted mode.

3. The storing apparatus according to claim 2, wherein: a sliding guide piece is arranged between at least one of the first link rod member and the second link rod member and at least one of the first base member and the second base member.

4. The storing apparatus according to claim 3, wherein: the sliding guide piece comprises arc grooves and guide shafts capable of sliding in the arc grooves.

5. The storing apparatus according to claim 4, wherein: the second base member comprises a top plate part fixedly connected to the body or the cover and side plate parts extending from side edges of the top plate part, wherein the arc grooves are formed in the side plate parts of the second base member.

6. The storing apparatus according to claim 5, wherein: two side plate parts arranged oppositely are provided, the first link rod member and the second link rod member each comprise two pivoting side plates arranged oppositely which are correspondingly pivoted on the two side plate parts of the second base member.

7. The storing apparatus according to claim 1, wherein: the body or the cover is provided with a locking hook, and at least one of the first pivot shaft and the third pivot shaft is constructed as a locking pin to be locked with the locking hook on the body or the cover in a pivoted mode.

8. The storing apparatus according to claim 7, wherein: the hinge mechanism further comprises a strength accumulating piece, and the strength accumulating piece is configured such that, when the hinge mechanism is released from the body or the cover, the strength accumulating piece comprised in the hinge mechanism keeps the hinge mechanism in a state suitable for being locked with the locking hook on the body or the cover when the cover is closed.

9. The storing apparatus according to claim 8, wherein: the strength accumulating piece is configured such that, when the cover rotates around the hinge mechanism to be opened, the strength accumulating piece is in a strength accumulating state for elastic deformation to produce elastic restoring force.

10. The storing apparatus according to claim 9, wherein: the strength accumulating piece is a spring, one end of the spring is connected to the fourth pivot shaft, the other end of the spring is connected to the first link rod member, and when the cover is in an opened state, the strength accumulating piece is in a stretched strength-accumulation state.

11. The storing apparatus according to claim 1, wherein: the second link rod member is closer to the edge than the first link rod member, wherein the second link rod member is bent to form an avoiding area on a side facing the edge, and the avoiding area is used to avoid abutting against the edge in an opening process of the cover.

12. The storing apparatus according to claim 11, wherein: the second link rod member abuts against the edge of the body to define a maximum opening position of the cover.

13. The storing apparatus according to claim 11, wherein: the first link rod member is an integrated member which comprises a base plate and pivoting side plates extending in a bent mode from two opposite sides of the base plate; and the second link rod member is a split member which comprises two parts separately arranged at two ends of the third pivot shaft and the fourth pivot shaft.

14. The storing apparatus according to claim 1, wherein: the second link rod member is closer to the edge than the first link rod member; wherein
a distance between the third pivot shaft and the fourth pivot shaft is smaller than a distance between the first pivot shaft and the second pivot shaft.

15. The storing apparatus according to claim 2, wherein: the second base member is fixedly connected to the body or the cover, and a padding block is configured between the second base member and the body or the cover.

16. The storing apparatus according to claim 1, wherein: the storing apparatus is a roof box suitable for being assembled on a top of the vehicle.

17. The storing apparatus according to claim 16, wherein: the hinge mechanisms are configured at two opposite edges of the storing apparatus, and when the cover is opened, the hinge mechanism at one of the edges is released from the body or the cover, and the cover rotates around the hinge mechanism at the other edge.

18. A storing apparatus, suitable for being attached to a vehicle, the storing apparatus comprising a body and a cover, wherein:
the body and the cover are connected through a hinge mechanism, and the hinge mechanism allows the cover to be rotatably opened and closed relative to at least one edge of the body; wherein
the hinge mechanism comprises a first link rod member and a second link rod member;
the first link rod member is swingably connected between the body and the cover, and at least two ends of the first link rod member are connected to the body and the cover in a pivoted mode respectively through a first pivot shaft and a second pivot shaft;
the second link rod member is swingably connected between the body and the cover, and at least two ends of the second link rod member are connected to the body and the cover in a pivoted mode respectively through a third pivot shaft and a fourth pivot shaft;
a distance between the first pivot shaft and the third pivot shaft and a distance between the second pivot shaft and the fourth pivot shaft are both kept unchanged, such that the body, the cover, the first link rod member and the second link rod member constitute a four-link mechanism; and
the first link rod member and the second link rod member are jointly connected with one end of the body or the cover, and are configured to be releasably connected to the body or the cover.

19. The storing apparatus according to claim 18, wherein: the hinge mechanism further comprises a first base member, and the first base member is configured to be releasably connected to the body or the cover; and
one end of the first link rod member and one end of the second link rod member are connected with the first base member in a pivoted mode.

20. The storing apparatus according to claim 18, wherein: the hinge mechanism further comprises a strength accumulating piece, and the strength accumulating piece is configured such that, when the hinge mechanism is released from the body or the cover, the strength accumulating piece comprised in the hinge mechanism keeps the hinge mechanism in a state suitable for being locked with the body or the cover when the cover is closed.
